(19) United States
(12) Patent Application Publication
(10) Pub. No.: US 2024/0006967 A1
(43) Pub. Date: Jan. 4, 2024

(54) FIELD WINDING TYPE ROTATING ELECTRIC MACHINE

(71) Applicant: DENSO CORPORATION, Kariya-city (JP)

(72) Inventor: MASAHIRO SEGUCHI, Kariya-city (JP)

(21) Appl. No.: 18/467,712

(22) Filed: Sep. 14, 2023

Related U.S. Application Data
(63) Continuation of application No. PCT/JP2022/007720, filed on Feb. 24, 2022.

(30) Foreign Application Priority Data
Mar. 18, 2021 (JP) 2021-045252

(51) Int. Cl. H02K 11/30; H02K 19/12

(52) U.S. Cl. CPC H02K 11/30; H02K 19/12

(57) ABSTRACT

A field winding type rotating electric machine includes a stator and a rotor. The stator has a stator core and multiphase stator windings. The rotor has a rotor core, a main pole portion provided at predetermined intervals in a circumferential direction and protruding radially from the rotor core, and a field winding wound around the main pole portion. A plurality of magnetic poles having alternating polarities in the circumferential direction are formed by flowing a field current through a field winding. The stator winding is provided on a peripheral surface of the stator core on the rotor side in a radial direction. The stator core is not provided with teeth protruding radially from the stator core toward the rotor.

### CROSS REFERENCE TO RELATED APPLICATIONS

This application is a continuation application of International Patent Application No. PCT/JP2022/007720 filed on Feb. 24, 2022, which designated the U.S. and based on and claims the benefits of priority of Japanese Patent Application No. 2021-045252 filed on Mar. 18, 2021. The entire disclosures of all of the above applications are incorporated herein by reference.

### TECHNICAL FIELD

The present disclosure relates to a field winding type rotating electric machine.

### BACKGROUND

Conventionally, a field winding type rotating electric machine having main pole portions provided at predetermined intervals in a circumferential direction and protruding radially from a rotor core, and field windings wound around the main pole portions is known.

### SUMMARY

A field-winding type rotating electric machine minimizes restrictions on the radial dimension of the rotor.

The present disclosure provides a stator having a stator core and multiphase stator windings, and a rotor having a rotor core, a main pole portion provided at predetermined intervals in a circumferential direction and protruding radially from the rotor core, and a field winding wound around the main pole portion. The rotor is formed with a plurality of magnetic poles whose polarities are alternated in the circumferential direction due to the field current flowing through the field winding. The stator winding is provided on a peripheral surface of the stator core on the rotor side in the radial direction. No teeth protruding radially from the stator core toward the rotor are provided.

### BRIEF DESCRIPTION OF THE DRAWINGS

The above and other objects, features and advantages of the present disclosure will become more apparent from the following detailed description made with reference to the accompanying drawings.

In the drawings:

FIG. 1 is an overall configuration diagram of a control system for a rotating electric machine according to a first embodiment;

FIG. 2 is a diagram showing an electrical configuration of an inverter and a rotating electric machine;

FIG. 3 is a cross-sectional view of the rotor and stator;

FIG. 4 is a diagram showing an electric circuit in the rotor;

FIG. 5 is a diagram showing changes in fundamental wave current, harmonic current, etc.;

FIG. 6 is a diagram showing changes in three-phase current;

FIG. 7 is a diagram showing an induced voltage generation pattern;

FIG. 8A is a diagram showing an electric circuit corresponding to pattern 2;

FIG. 8B is a diagram showing an electrical circuit corresponding to pattern 3;

FIG. 9 is a diagram showing the configuration of a stator winding according to a second embodiment;

FIG. 10 is a cross-sectional view of a rotor and a stator according to a third embodiment;

FIG. 11 is a longitudinal sectional view of the rotor and the stator; and

FIG. 12 is a longitudinal sectional view of a rotor and a stator according to another embodiment.

### DETAILED DESCRIPTION

In an assumable example, a field winding type rotating electric machine having main pole portions provided at predetermined intervals in a circumferential direction and protruding radially from a rotor core, and field windings wound around the main pole portions is known. A plurality of magnetic poles having alternating polarities in the circumferential direction are formed by flowing a field current through the field winding.

A rotating electric machine includes a stator arranged to face a rotor in a radial direction. The stator includes a stator core and teeth that are provided at predetermined intervals in the circumferential direction and protrude from the stator core to the rotor side in the radial direction. A stator winding is wound around the teeth.

In a rotating electric machine in which teeth protrude toward the rotor, the radial dimension of the rotor may be restricted in order to secure the magnetic path of the stator and winding space. In this case, the space for arranging the field winding is restricted, and the cross-sectional area of the field winding is reduced. As a result, there is concern that the resistance value of the field winding increases, the loss generated in the field winding increases, and the magnitude of the magnetic pole magnetic flux decreases.

A field-winding type rotating electric machine can minimize restrictions on the radial dimension of the rotor.

The present disclosure provides a stator having a stator core and multiphase stator windings, and a rotor having a rotor core, a main pole portion provided at predetermined intervals in a circumferential direction and protruding radially from the rotor core, and a field winding wound around the main pole portion. The rotor is formed with a plurality of magnetic poles whose polarities are alternated in the circumferential direction due to the field current flowing through the field winding. The stator winding is provided on a peripheral surface of the stator core on the rotor side in the radial direction. No teeth protruding radially from the stator core toward the rotor are provided.

In the present disclosure, the stator winding is provided on the rotor side in the radial direction of the stator core, and no teeth are provided that protrude from the stator core to the rotor side in the radial direction. Therefore, restriction on the size of the rotor in the radial direction can be eliminated as much as possible, and restriction on the arrangement space of the field winding can be eliminated as much as possible. As a result, the cross-sectional area of the field winding can be increased, the loss generated in the field winding can be reduced, and the magnitude of the magnetic pole magnetic flux can be increased.

Moreover, since no teeth are provided, the possibility is eliminated that the teeth may or may not be opposed to the main pole portion as the rotor rotates. As a result, fluctuations in the magnetic resistance of the magnetic circuit of the rotor and stator can be suppressed, and torque ripple of the rotating electric machine can be reduced.

### First Embodiment

A first embodiment of a rotating electric machine according to the present disclosure will be described below with reference to the drawings.

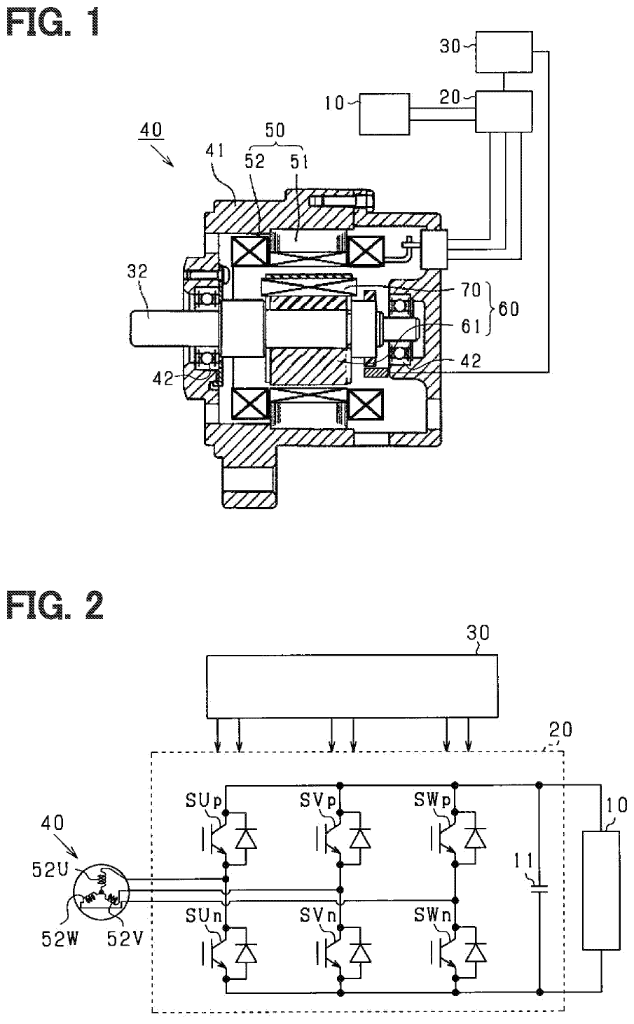

First, with reference to FIG. 1, a control system including a rotating electric machine will be described. The control system includes a DC power supply 10, an inverter 20, a control unit 30 and a rotating electric machine 40. The rotating electric machine 40 is a field winding type synchronous machine. In the present embodiment, the control unit 30 controls the rotating electric machine 40 so that the rotating electric machine 40 functions as an ISG (Integrated Starter Generator) or MG (Motor Generator), which is a motor and generator. For example, the rotating electric machine 40, the inverter 20, and the control unit 30 are provided to form an electromechanical integrated drive device, or the rotating electric machine 40, the inverter 20, and the control unit 30 are each constituted by respective components.

An overview of the rotating electric machine 40 will be described with reference to FIG. 1. The rotating electric machine 40 includes a housing 41, and a stator 50 and a rotor 60 that are accommodated within the housing 41. The rotating electric machine 40 of the present embodiment is of an inner rotor type in which the rotor 60 is arranged radially inside the stator 50.

The stator 50 includes a stator core 51 and stator winding 52. The stator winding 52 is made of copper wire, for example, and includes U-, V-, and W-phase windings 52U, 52V, and 52W arranged with an electrical angle difference of 120 degrees from each other.

The rotor 60 has a rotor core 61 and a field winding 70. The field winding 70 is formed by compression molding, for example. As a result, the space factor is improved and an assembling property of the field winding 70 is improved. The field winding 70 may be made of, for example, an aluminum wire. The aluminum wire has a small specific gravity and can reduce a centrifugal force when the rotor 60 rotates. The aluminum wire has lower strength and hardness than the copper wire and are suitable for compression molding. The field winding 70 may be made of copper wire. The field winding 70 will be detailed later.

A rotating shaft 32 is inserted through a center hole of the rotor core 61. The rotating shaft 32 is rotatably supported by the housing 41 via bearings 42.

As shown in FIG. 2, the inverter 20 is configured by serially connecting U-, V-, and W-phase upper arm switches SUp, SVp, and SWp and U-, V-, and W-phase lower arm switches SUn, SVn, and SWn. First ends of U-, V-, and W-phase windings 52U, 52V, and 52W are connected to connecting points between U-, V-, and W-phase upper arm switches SUp, SVp, and SWp and U-, V-, and W-phase lower arm switches SUn, SVn, and SWn. The second ends of the U-, V- and W-phase windings 52U, 52V and 52W are connected at a neutral point. That is, in the present embodiment, the U-, V-, and W-phase windings 52U, 52V, and 52W are star-connected. In the present embodiment, each switch SUp to SWn is an IGBT. A freewheel diode is connected in anti-parallel to each of the switches SUp to SWn.

A positive terminal of a DC power supply 10 is connected to the collectors of the U-, V-, and W-phase upper arm switches SUp, SVp, and SWp. A negative terminal of the DC power supply 10 is connected to the emitters of the U-, V-, and W-phase lower arm switches SUn, SVn, and SWn. A smoothing capacitor 11 is connected in parallel with the DC power supply 10.

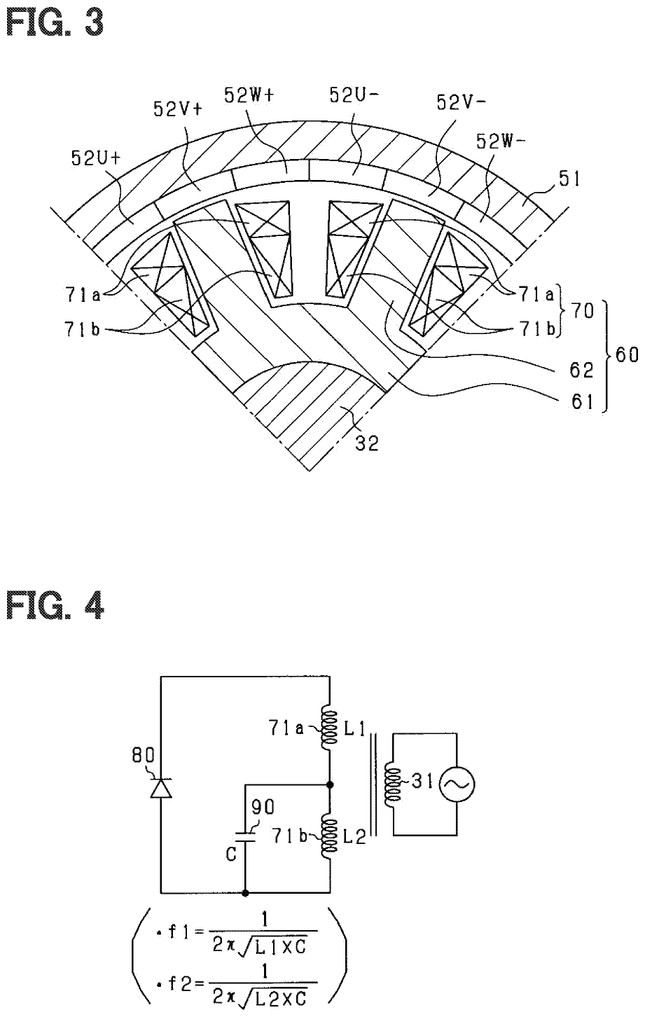

Next, the stator 50 and the rotor 60 will be described with reference to FIG. 3.

Both the stator 50 and the rotor 60 are arranged coaxially with the rotating shaft 32. In the following description, a direction in which the rotating shaft 32 extends is defined as an axial direction, a direction extending radially from the center of the rotating shaft 32 is defined as a radial direction, and a direction extending circumferentially about the rotating shaft 32 is defined as a circumferential direction.

The rotor 60 is made of a soft magnetic material, and is made of laminated steel plates, for example. The rotor 60 has a cylindrical rotor core 61 and a plurality of main pole portions 62 protruding radially outward from the rotor core 61. In the present embodiment, eight main pole portions 62 are provided at regular intervals in the circumferential direction.

The field winding 70 has a first winding portion 71a and a second winding portion 71b. In each main pole portion 62, the first winding portion 71a is wound radially outward, and the second winding portion 71b is wound radially inward of the first winding portion 71a. In each main pole portion 62, the winding directions of the first winding portion 71a and the second winding portion 71b are the same. Moreover, in the main pole portions 62 adjacent in the circumferential direction, the winding direction of the winding portions 71a and 71b wound on one main pole portion 62 is opposite to the winding direction of the winding portions 71a and 71b wound on the other main pole portion 62. Therefore, the magnetization directions of the main pole portions 62 adjacent to each other in the circumferential direction are opposite to each other.

FIG. 4 shows an electric circuit on the side of the rotor 60, which includes each of the winding portions 71a and 71b wound around a common main pole portion 62. The rotor 60 is provided with a diode 80 as a rectifying element and a capacitor 90. A cathode of the diode 80 is connected to the first end of the first winding portion 71a, and the second end of the first winding portion 71a is connected to the first end of the second winding portion 71b. An anode of the diode 80 is connected to the second end of the second winding portion 71b. The capacitor 90 is connected in parallel to the second winding portion 71b. In FIG. 4, L1 indicates the inductance of the first winding portion 71a, L2 indicates the inductance of the second winding portion 71b, and C indicates the capacitance of the capacitor 90.

Next, the control unit 30 will be described. A part or all of each function of the control unit 30 may be configured in hardware by, for example, one or a plurality of integrated circuits. Further, each function of the control unit 30 may be configured by, for example, software recorded in a non-transitional substantive recording medium and a computer executing the software.

The control unit 30 generates drive signals for turning on and off the switches SUp to SWn that form the inverter 20. Specifically, when the rotating electric machine 40 is driven as an electric motor, in order to convert the DC power output from the DC power supply 10 into AC power and supply it to the U-, V-, and W-phase windings 52U, 52V, and 52W, the control unit 30 generates drive signals for turning on and off each of the arm switches SUp to SWn, and supplies the generated drive signals to the gates of each of the arm switches SUp to SWn. On the other hand, when the rotating electric machine 40 is driven as a generator, the control unit 30 converts the AC power output from the U-, V-, and W-phase windings 52U, 52V, and 52W into DC power and supplies it to the DC power supply 10 so that the control unit 30 generates a drive signal for turning on/off the arm switches SUp to SWn.

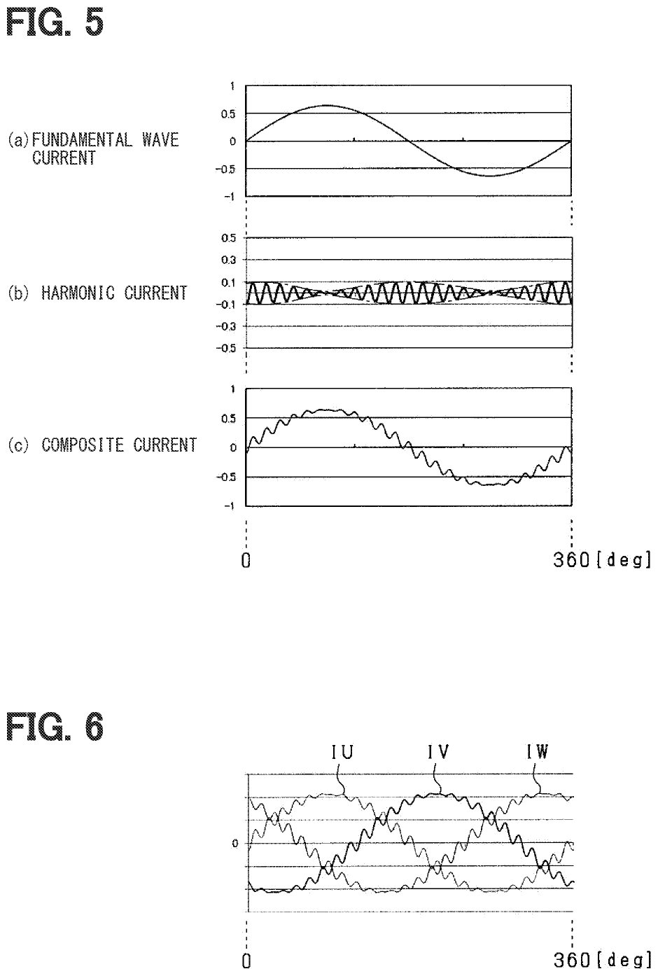

The control unit 30 turns on and off each of the switches SUp to SWn so that the composite current of the fundamental wave current and the harmonic current flows through the phase windings 52U, 52V, and 52W. The fundamental wave current, as shown in FIG. 5(a), is a current that mainly causes the rotating electric machine 40 to generate torque. The harmonic current is a current that mainly excites the field winding 70, as shown in FIG. 5(b). FIG. 5(c) shows the phase current as a composite current of the fundamental wave current and the harmonic current. The values on the vertical axis shown in FIG. 5 indicate the relative relationship between the magnitudes of the waveforms shown in FIGS. 5(a) to 5(c). The phase currents IU, IV, IW flowing through the respective phase windings 52U, 52V, 52W are shifted by an electrical angle of 120°, as shown in FIG. 6. The harmonic current may be a triangular wave current.

In the present embodiment, as shown in FIGS. 5(a) and 5(b), the envelope of the harmonic current has ½ period of the fundamental current. The envelope is shown by a dashed line in FIG. 5(b). The timing at which the envelope reaches its peak value is shifted from the timing at which the fundamental wave current reaches its peak value. The control unit 30 independently controls the amplitude and period of the fundamental wave current and the harmonic current. By applying the harmonic current shown in FIG. 5(b), the maximum value of the phase current flowing through each phase winding 52U, 52V, 52W can be reduced, and the torque of the rotating electric machine 40 can be set to the commanded torque without increasing the capacity of the inverter 20.

The harmonic current is not limited to that shown in FIG. 5(b), and the harmonic current may be phase-shifted. For example, the harmonic current may be obtained by shifting the phase of the harmonic current shown in FIG. 5(b) by ¼ period of the fundamental current.

In the present embodiment, a series resonance circuit is configured by the first winding portion 71a, the capacitor 90 and the diode 80, and a parallel resonance circuit is configured by the second winding portion 71b and the capacitor 90. A first resonance frequency that is the resonance frequency of the series resonance circuit is referred to as f1, and a second resonance frequency that is the resonance frequency of the parallel resonance circuit is referred to as f2. The resonance frequency f1 and the resonance frequency f2 are represented by the following equations (eq1) and (eq2).

[Equation 1]

f1=½π\sqrt{L1*C} (eq1)

[Equation 2]

f2=½π\sqrt{L2*C} (eq2)

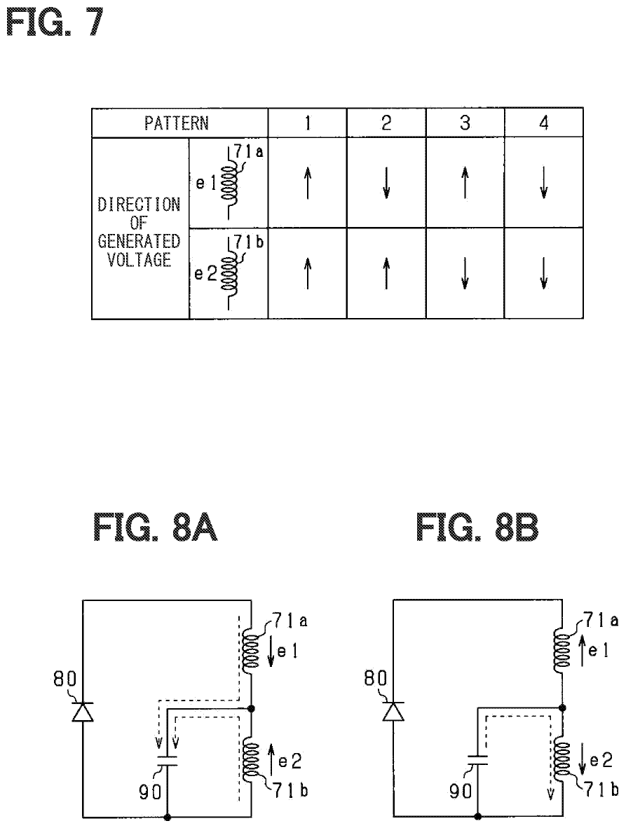

When harmonic currents flow through the phase windings 52U, 52V, and 52W, fluctuations due to the harmonics of the main magnetic flux occur in the magnetic circuit including the main pole portions 62 adjacent in the circumferential direction, the rotor core 61, and the stator core 51. When the main magnetic flux fluctuates, induced voltages are generated in the first and second winding portions 71a and 71b, respectively, and currents are induced in the first and second winding portions 71a and 71b. At this time, when induced voltages with the same polarity are generated in the first and second winding portions 71a and 71b, the induced currents in the first and second winding portions 71a and 71b are not canceled, and the induced current increases, as shown in patterns 1 and 4 in FIG. 7. The diode 80 rectifies the current flowing through the first and second winding portions 71a and 71b in one direction. As a result, a field current flows through the field winding 70 in the direction rectified by the diode 80, and the field winding is excited. In FIGS. 8A and 8B, e1 indicates the induced voltage generated in the first winding portion 71a, and e2 indicates the induced voltage generated in the second winding portion 71b.

On the other hand, when a harmonic current flows, leakage magnetic flux is likely to occur in addition to fluctuations in the main magnetic flux. The leakage magnetic flux flows across the main pole portions 62 adjacent in the circumferential direction from one to the other without passing through the rotor core 61 and interlinks the field winding 70. At this time, the leakage magnetic fluxes interlinking with the winding portions 71a and 71b are also generated. When the leakage magnetic flux interlinks with the field winding 70, an induced voltage is generated in one direction in the first winding portion 71a, and an induced voltage in a different direction is generated in the second winding portion 71b. As a result, the total value of the currents induced in each of the first and second winding portions 71a and 71b is reduced, and the field current flowing through the field winding 70 is reduced.

Therefore, in the present embodiment, a capacitor 90 is connected in parallel to the second winding portion 71b. Therefore, as shown in patterns 2 and 3 in FIG. 7, even if the induced voltages generated in the first and second winding portions 71a and 71b have opposite polarities, the induced current flows through the capacitor and the induced current flowing through the first and second winding portions 71a and 71b is not canceled each other. Therefore, as shown in FIG. 8(a), the current induced in the first winding portion 71a and the current induced in the second winding portion 71b flow through the capacitor 90 to the anode side of the diode 80, or as shown in FIG. 8B, the current flows from the capacitor 90 to the anode side of the diode via the second winding portion 71b. As a result, the field current flowing through the field winding 70 can be increased.

In the present embodiment, the control unit 30 sets the frequency of the harmonic current to a frequency near the first resonance frequency f1 or a frequency near the second resonance frequency f2. As a result, the excitation can be enhanced to reduce the amplitude of the harmonic current, and the torque ripple of the rotating electric machine 40 can be reduced.

Returning to the description of FIG. 3, the stator 50 is made of a soft magnetic material, such as laminated steel plates. The stator 50 has the cylindrical stator core 51. In the present embodiment, the stator 50 has a toothless structure without teeth for forming slots. Therefore, the inner peripheral surface of the stator core 51 in the radial direction becomes a peripheral surface without unevenness.

The U-phase winding 52U has U-phase intermediate conductor portions 52U+ and 52U− serving as coil sides extending axially and arranged side by side in the circumferential direction. The V-phase winding 52V has V-phase intermediate conductor portions 52V+ and 52V− serving as coil sides extending in the axial direction and arranged side by side in the circumferential direction. The W-phase winding 52W has W-phase intermediate conductor portions 52W+ and 52W serving as coil sides extending in the axial direction and arranged side by side in the circumferential direction. The + and − signs of each intermediate conductor portion indicate that the direction of current flow is opposite. In the intermediate conductor portion, the length dimension in the radial direction is smaller than the length dimension in the circumferential direction. Moreover, in the present embodiment, the intermediate conductor portions adjacent in the circumferential direction are in contact with each other.

The effect of the present embodiment detailed above is described.

No teeth protruding radially inward from the stator core 51 are provided. Therefore, the inner diameter of the stator 50 can be reduced, and the outer diameter of the rotor 60 can be increased. As a result, the space for arranging the field winding can be increased, and the cross-sectional area of the field winding 70 can be increased. As a result, the electric resistance value [Ω] of the field winding 70 can be reduced, and the loss generated in the field winding 70 can be reduced.

Further, since the electrical resistance can be reduced, the magnitude of the magnetic pole magnetic flux can be increased by increasing the field current. As a result, the torque of rotating electric machine 40 can be increased.

Since no teeth are provided, the possibility is eliminated that the teeth may or may not be opposed to the main pole portion 62 as the rotor 60 rotates. As a result, fluctuations in the magnetic resistance of the magnetic circuit of the rotor 60 and stator 50 can be suppressed, and torque ripple of the rotating electric machine 40 can be reduced.

Since the teeth are not provided, the outer diameter of the rotor 60 can be increased, the area of the acting surface and the acting diameter of the field magnetic flux can be increased, and the torque of the rotating electric machine 40 can be increased. In the stator winding 52, the intermediate conductor portions adjacent in the circumferential direction are in contact with each other. Therefore, the thickness dimension in the radial direction of the intermediate conductor portion can be reduced, and the outer diameter dimension of the rotor 60 can be increased accordingly. As a result, the space for arranging the field winding 70 can be increased, and the cross-sectional area of the field winding 70 can be increased. As a result, the resistance value of the field winding 70 can be reduced, and the field current can be increased.

### Second Embodiment

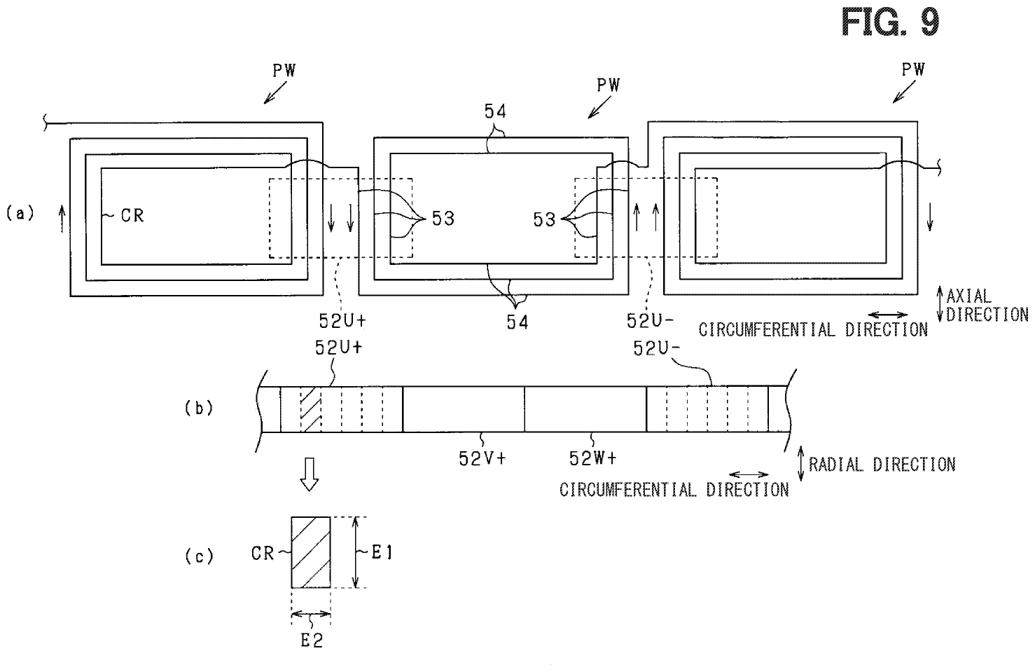

Hereinafter, a second embodiment will be described with reference to the drawings, focusing on differences from the first embodiment. In the present embodiment, as shown in FIG. 9, the configuration of the stator winding 52 is changed. FIG. 9(a) is a diagram showing the U-phase winding 52U that constitutes the stator winding 52, developed in the circumferential direction. As shown in FIG. 9(a), the U-phase winding 52U is configured by serially connecting partial windings PW each made of a concentrated conductive wire CR. Hereinafter, a U-phase will be described, as an example.

The partial winding PW includes a pair of conductor portions 53 that extend in the axial direction and are spaced apart in the circumferential direction, and transition portions 54 that are provided on one end side and the other end side in the axial direction and connect the pair of conductor portions 53 in an annular fashion. FIG. 9(a) shows three partial windings PW. As indicated by the arrow in the figure, the intermediate conductor portions 52U+ and 52U− are formed by the conductor portions 53 of the circumferentially adjacent partial windings PW having the same current flow direction. In the example shown in FIGS. 9(a) and 9(b), the intermediate conductor portion 52U+ is composed of six conductor portions 53 whose current flow direction is the first direction, and the intermediate conductor portion 52U− is composed of the six conductor portions 53 whose current flow direction is the second direction opposite to the first direction.

FIG. 9(b) is a view showing the intermediate conductor portions of each phase developed in the circumferential direction, and FIG. 9(c) is a cross-sectional view of each conductive wire CR forming the intermediate conductor portion 52U+. As shown in FIGS. 9(b) and 9(c), in the U-phase intermediate conductor portion which is the coil side, a radial dimension E1 of the conductive wire CR is longer than a circumferential dimension E2 of the conductive wire CR.

When the main magnetic flux from the rotor 60 interlinks the intermediate conductor portion, the current flowing through the conductive wire CR tends to be biased toward the circumferential ends of the conductive wire CR. In this case, the apparent electrical resistance value [Ω] of the conductive wire CR increases. In this regard, in the present embodiment, in the intermediate conductor portion, the radial dimension E1 of the conductive wire CR is greater than the circumferential dimension E2 of the conductive wire CR. As a result, even if the current is biased, the portion extending in the radial direction of the conductive wire CR can be secured as a current flow portion, and an increase in the apparent electrical resistance value can be suppressed. As a result, loss generated in the stator winding can be reduced.

### Third Embodiment

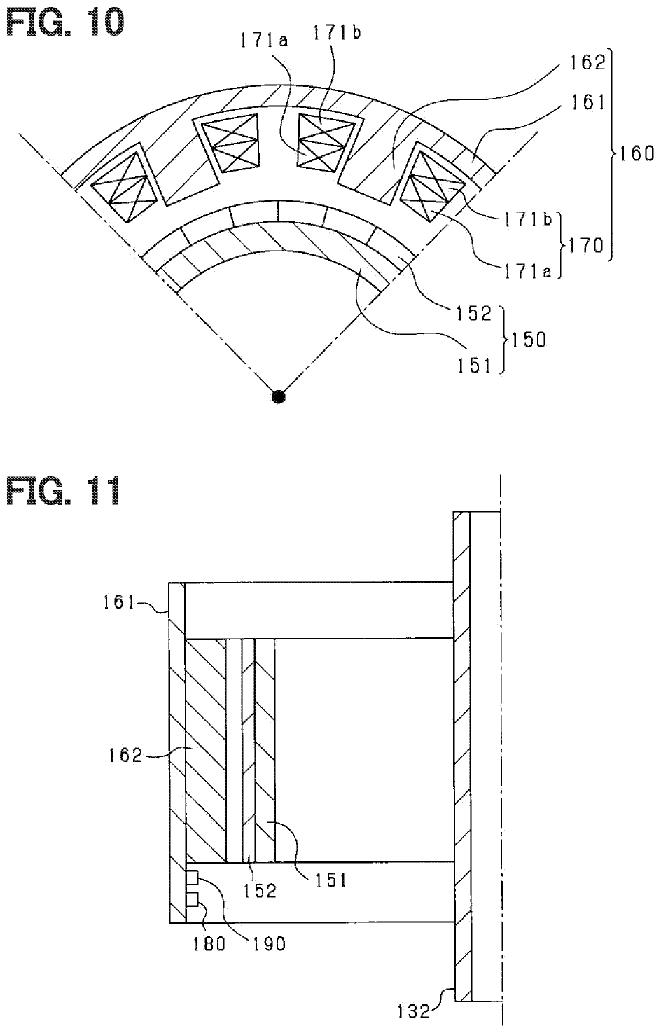

Hereinafter, a third embodiment will be described with reference to the drawings, focusing on differences from the first embodiment. In the present embodiment, as shown in FIGS. 10 and 11, the rotating electric machine is of an outer rotor type in which a rotor 160 is arranged radially outside a stator 150.

The stator 150 includes a stator core 151 and three-phase stator windings 152. The rotor 160 has a cylindrical rotor core 161 and field windings 170. A rotating shaft 132 of the rotating electric machine is fixed to the rotor core 161. The rotor 160 and the stator 150 are coaxially arranged. In FIGS. 10 and 11, a member for fixing the rotor core 161 to the rotating shaft 132 is omitted.

The rotor 160 is made of a soft magnetic material, and is made of laminated steel plates, for example. The rotor 160 has a cylindrical rotor core 161, a plurality of main pole portions 162 protruding radially inward from the rotor core 161, and a field winding 170. In the present embodiment, eight main pole portions 162 are provided at regular intervals in the circumferential direction.

The field winding 170 has a first winding portion 171a and a second winding portion 171b. The first winding portion 171a corresponds to the first winding portion 71a of the first embodiment, and the second winding portion 171b corresponds to the second winding portion 71b of the first embodiment. In each main pole portion 162, the first winding portion 171a is wound radially outward, and the second winding portion 171b is wound radially inward of the first winding portion 171a. In each main pole portion 162, the winding directions of the first winding portion 171a and the second winding portion 171b are the same. Moreover, in the main pole portions 162 adjacent in the circumferential direction, the winding direction of the winding portions 171a and 171b wound on one main pole portion 162 is opposite to the winding direction of the winding portions 171a and 171b wound on the other main pole portion 162. Therefore, the magnetization directions of the main pole portions 162 adjacent to each other in the circumferential direction are opposite to each other.

The rotor 160 includes a diode 180 and a capacitor 190. The diode 180 corresponds to the diode 80 of the first embodiment, and the capacitor 190 corresponds to the capacitor 90 of the first embodiment. An electric circuit including a series/parallel resonant circuit composed of the field winding 170, the diode 180 and the capacitor 190 is the same as the circuit of FIG. 4 of the first embodiment.

The stator 150 includes, in the axial direction, a portion corresponding to a coil side facing a main pole portion 162 in the rotor 160 in the radial direction, and a portion corresponding to a coil end that is the outer side of the coil side in the axial direction. In this case, the stator core 151 is provided in a range corresponding to the coil side in the axial direction.

The stator winding 152 has a plurality of phase windings. The phase windings of respective phases are disposed in a predetermined order in the circumferential direction to be formed in a cylindrical shape. In the present embodiment, the stator winding 52 has three-phase windings including the U-phase, the V-phase, and the W-phase windings. The stator winding 152 of each phase has an intermediate conductor portion extending in the axial direction and arranged in a range including the coil side, and a jumper portion connecting the intermediate conductor portions 53 of the same phase adjacent to each other in the circumferential direction. In the present embodiment, the intermediate conductor portions adjacent in the circumferential direction are in contact with each other.

The stator core 151 is made of a soft magnetic material, such as laminated steel plates. The stator core 151 has a cylindrical shape. In the present embodiment, the stator 150 has a toothless structure without teeth for forming slots. Therefore, the outer peripheral surface of the stator core 151 in the radial direction becomes a peripheral surface without unevenness. As a result, for example, a member for fixing the field winding 170 becomes unnecessary, and the space for arranging the field winding 170 can be increased. As a result, the resistance value of the field winding 70 can be reduced, the loss generated in the field winding 70 can be reduced, and the magnetic pole magnetic flux can be increased by increasing the field current.

In the present embodiment, the diode 180 and the capacitor 190 are provided on the peripheral surface that is shifted from the peripheral surface that faces the coil side of the stator winding 152 in the radial direction toward the end portion side in the axial direction, in the radial inner peripheral surface of the rotor core 161.

The magnetic flux generated by energization of the stator windings 152 has a large effect on the circumferential surface facing the coil side of the stator windings 152 in the radial direction of the inner peripheral surface of the rotor core 161. In this regard, according to the present embodiment, it is possible to suppress the influence of the magnetic flux generated by the energization of the stator winding 152 on the diode 180 and the capacitor 190. As a result, for example, the resonance frequencies f1 and f2 of each resonance circuit can be prevented from greatly deviating from the frequencies assumed at the time of design, and the influence of the magnetic flux generated by the energization of the stator winding 152 on the field current can be suitably suppressed. Further, according to the present embodiment, it is possible to suppress the influence of the field magnetic flux generated by the flow of the field current on the diode 180 and the capacitor 190.

The diode 180 and the capacitor 190 are arranged on the inner peripheral surface of the rotor core 161. Therefore, even if centrifugal force acts on the diode 180 and the capacitor 190 as the rotor 160 rotates, problems such as separation of the diode 180 and the capacitor 190 from the rotor core 161 can be suppressed.

Since the diode 180 and the capacitor 190 can be placed away from the stator winding 152 and the field winding 170, the influence of the heat generated by the stator winding 152 and the field winding 170 on the diode 180 and the capacitor 190 can be suppressed.

### Other Embodiments

The above embodiments may be changed and carried out as follows.

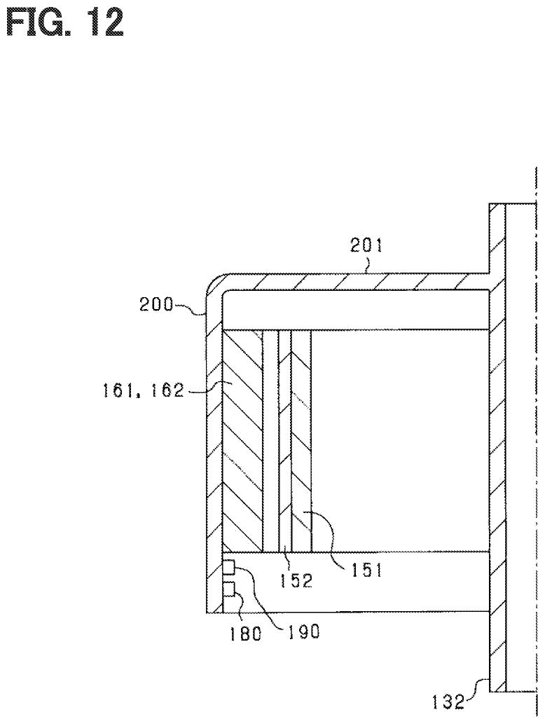

The rotating electric machine is not limited to the one illustrated in the third embodiment, and may be, for example, the one shown in FIG. 12. In FIG. 12, the same configurations as those shown in FIGS. 10 and 11 are designated by the same reference numerals for convenience. The rotating electrical machine includes a cylindrical portion 200 having a cylindrical shape and an end plate portion 201 having a disc shape. The radially outer peripheral surface of the rotor core 161 is fixed to the radially inner peripheral surface of the cylindrical portion 200. One end of the end plate portion 201 is connected to the axial end portion of the cylindrical portion 200, and the other end of the end plate portion 201 is connected to the rotating shaft 132. The cylindrical portion 200 and the rotor 160 are arranged coaxially. The cylindrical portion 200 and the end plate portion 201 may be made of a magnetic material or may be made of a non-magnetic material.

The diode 180 and the capacitor 190 are provided on the peripheral surface that is shifted from the peripheral surface that faces the coil side of the stator winding 152 in the radial direction toward the end portion side in the axial direction, in the radial inner peripheral surface of the cylindrical portion 200. Even in this case, the same effects as in the third embodiment can be obtained.

In the third embodiment, the stator 150 in which the teeth are provided may be used.

A protrusion portion that protrudes in the radial direction and do not function as teeth may be provided on the peripheral surface of the stator core. In this case, the length dimension in the radial direction of the protrusion portion may be, for example, less than half the length dimension in the radial direction of the intermediate conductor portion.

The control units and methods thereof described in the present disclosure may be implemented by a dedicated computer including a processor programmed to execute one or more functions embodied by a computer program and a memory. Alternatively, the control units and the methods thereof described in the present disclosure may be implemented by a dedicated computer including a processor with one or more dedicated hardware logic circuits. Alternatively, the control circuit and method described in the present disclosure may be realized by one or more dedicated computer, which is configured as a combination of a processor and a memory, which are programmed to perform one or more functions, and a processor which is configured with one or more hardware logic circuits. The computer programs may be stored, as instructions to be executed by a computer, in a tangible non-transitory computer-readable medium.

Although the present disclosure has been described in accordance with the embodiments, it is understood that the present disclosure is not limited to the embodiments and structures disclosed therein. The present disclosure encompasses various modifications and variations within the scope of equivalents. In addition, while the various combinations and configurations, which are preferred, other combinations and configurations, including more, less or only a single element, are also within the spirit and scope of the present disclosure.

What is claimed is:

1. A field winding type rotating electric machine, comprising:
a stator having a stator core and multiphase stator windings;
a rotor including a rotor core, main pole portions provided at predetermined intervals in a circumferential direction and protruding radially from the rotor core and a field winding wound around the main pole portion, and being configured to form a plurality of magnetic poles with alternating polarities in the circumferential direction by field current flowing through the field winding;
a control unit configured to control a harmonic current to flow in the stator windings for inducing a field current in the field winding;
a diode; and
a capacitor, wherein
the rotor is arranged radially outside the stator,
the field winding has a series connection of a first winding portion and a second winding portion,
each of the first winding portion and the second winding portion is wound around each of the main pole portions,
the diode has one end connected to the first winding portion side and the other end connected to the second winding portion side among both ends of the series connection,
the capacitor is connected in parallel to the second winding portion,
a series resonance circuit including the first winding portion and the capacitor and a parallel resonance circuit including the second winding portion and the capacitor are configured, and
the diode and the capacitor are provided on a peripheral surface that is shifted from the peripheral surface that faces a coil side of the stator winding in a radial direction toward an end portion side in an axial direction, in a radial inner peripheral surface of the rotor.

2. The field winding type rotating electric machine according to claim 1, wherein
the stator winding is provided on a peripheral surface of the stator core on the rotor side in the radial direction, and
no teeth protruding radially from the stator core toward the rotor are provided.

3. The field winding type rotating electric machine according to claim 1, wherein
the control unit sets a frequency of the harmonic current to a frequency near a resonance frequency of the series resonance circuit or a frequency near a resonance frequency of the parallel resonance circuit.

4. The field winding type rotating electric machine according to claim 1, wherein
the stator winding of each phase includes a pair of intermediate conductor portions extending in the axial direction and spaced apart in the circumferential direction, and a transition portion that is provided on one end side and the other end side in the axial direction for connecting the pair of intermediate conductor portions in an annular fashion,
a conductive wire is wound in multiple layers in the pair of intermediate conductor portions and each of the transition portions, and
in the intermediate conductor portion, a radial dimension of the conductive wire is greater than a circumferential dimension of the conductive wire.

5. The field winding type rotating electric machine according to claim 1, wherein
the stator winding of each phase has intermediate conductor portions extending in the axial direction and arranged side by side in the circumferential direction, and
the intermediate conductor portions adjacent in the circumferential direction are in contact with each other.
